(19) United States
(12) Patent Application Publication
(10) Pub. No.: US 2020/0180566 A1
(43) Pub. Date: Jun. 11, 2020

(54) DEVICE FOR CLEANING IN-VEHICLE SENSOR

(71) Applicant: DENSO CORPORATION, Kariya-shi, Aichi-ken (JP)

(72) Inventor: Keita SAITO, Kariya-shi (JP)

(73) Assignee: DENSO CORPORATION, Kariya-shi, Aichi-ken (JP)

(21) Appl. No.: 16/349,305

(22) PCT Filed: Nov. 17, 2017
(86) PCT No.: PCT/JP2017/041478

§ 371 Date: May 13, 2019

(30) Foreign Application Priority Data
Jan. 10, 2017 (JP) 2017-001910
Aug. 30, 2017 (JP) 2017-165780

(51) Int. Cl. B60S 1/48

(52) U.S. Cl. CPC B60S 1/481

(57) ABSTRACT

An in-vehicle sensor cleaning device ejects fluid toward a sensing surface of an in-vehicle sensor to clean the sensing surface. The in-vehicle sensor is arranged at a front side of a vehicle, a rear side of the vehicle, or one of lateral sides of the vehicle. The in-vehicle sensor cleaning device includes a first ejection port and a second ejection port configured to eject fluid toward the sensing surface of the in-vehicle sensor and a motor-driven pump that supplies fluid to the first ejection port and the second ejection port. The fluid ejected from the first ejection port is set to have a greater flow rate per unit time than the fluid ejected from the second ejection port.

### TECHNICAL FIELD

The present invention relates to an in-vehicle sensor cleaning device.

### BACKGROUND ART

Recent vehicles include an in-vehicle sensor such as an in-vehicle camera, and signals (such as imaging signals) from the in-vehicle sensor are widely utilized. Such an in-vehicle sensor has a sensing surface (such as a lens or protection glass) where foreign material such as mud may collect. A cleaning device cleans the sensing surface of an in-vehicle sensor by ejecting fluid such as gas or liquid from an ejection port (see Patent Document 1, for example). Foreign material is more likely to collect on a sensing surface arranged at the front side of the vehicle than a sensing surface arranged at the rear side of the vehicle. Thus, fluid is delivered to an ejection port at the front side of a vehicle with a higher output than an ejection port at the rear side of the vehicle so that the fluid is ejected in a greater amount or at a higher pressure at the front side of the vehicle.

### PRIOR ART DOCUMENT

### Patent Document

Patent Document 1: Japanese Laid-Open Patent Publication No. 2015-137070

### SUMMARY OF THE INVENTION

### Problems that are to be Solved by the Invention

In recent years, vehicles include a plurality of in-vehicle sensors at the front side and a plurality of in-vehicle sensors at the rear side. Further, the in-vehicle sensors include laser, radar, and Lider that have a larger sensing surface than an in-vehicle camera. There is a demand for an in-vehicle sensor cleaning device that is optimal for such cases.

It is an object of the present invention to provide an in-vehicle sensor cleaning device that suitably cleans the in-vehicle sensor arranged at the front side, the rear side, or a lateral side of a vehicle.

### Means for Solving the Problem

In order to achieve the above object, an in-vehicle sensor cleaning device ejects fluid toward a sensing surface of an in-vehicle sensor to clean the sensing surface. The in-vehicle sensor is arranged at a front side of a vehicle, a rear side of the vehicle, or one of lateral sides of the vehicle. The in-vehicle sensor cleaning device includes a first ejection port and a second ejection port configured to eject fluid toward the sensing surface of the in-vehicle sensor and a motor-driven pump that supplies fluid to the first ejection port and the second ejection port. The fluid ejected from the first ejection port is set to have a greater flow rate per unit time than the fluid ejected from the second ejection port.

### BRIEF DESCRIPTION OF THE DRAWINGS

FIG. 1 is a schematic diagram showing a portion of a vehicle according to one embodiment of the present invention.

FIG. 2 is a schematic diagram of an in-vehicle sensor cleaning device in FIG. 1.

FIG. 3 is a schematic diagram of an in-vehicle sensor cleaning device in another example.

FIG. 4 is a schematic diagram of an in-vehicle sensor cleaning device in another example.

FIG. 5 is a schematic diagram of an in-vehicle sensor cleaning device in another example.

FIG. 6 is a schematic diagram of a vehicle in another example.

FIG. 7 is a schematic diagram of an in-vehicle sensor cleaning device in another example.

FIG. 8 is a schematic diagram of an in-vehicle sensor cleaning device in another example.

FIG. 9 is a cross-sectional diagram of a switch branching unit serving as a branching portion in another example.

FIG. 10 is a schematic diagram of an in-vehicle sensor cleaning device in another example.

FIG. 11 is a schematic diagram of an in-vehicle sensor cleaning device in another example.

### EMBODIMENTS OF THE INVENTION

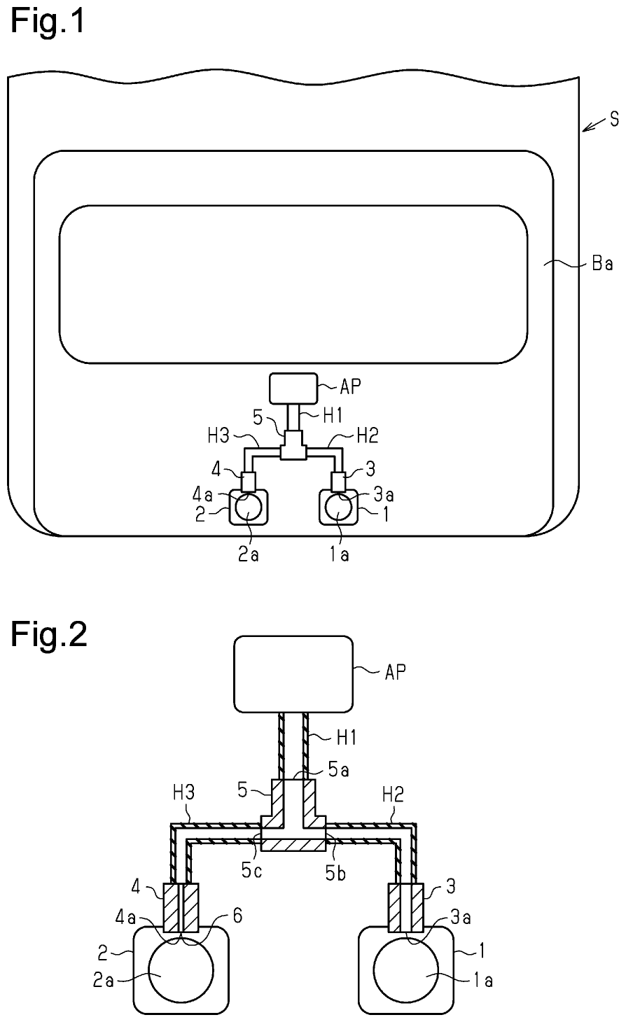

One embodiment of a vehicle will now be described with reference to FIGS. 1 and 2.

As shown in FIG. 1, the rear of a vehicle S includes a rear door Ba. The rear door Ba includes a backward movement in-vehicle camera 1, which serves as an in-vehicle sensor and a first in-vehicle sensor, and a rearview mirror in-vehicle camera 2, which serves as an in-vehicle sensor and a second in-vehicle sensor. A first lens surface 1a, which serves as a sensing surface of the backward movement in-vehicle camera 1, is exposed and directed diagonally downward at the rear of the vehicle. A second lens surface 2a, which serves as a sensing surface of the rearview mirror in-vehicle camera 2 is exposed and directed toward the rear of the vehicle (substantially horizontal direction). For example, when the shift lever (not shown) of a transmission is moved to the reverse position, the backward movement in-vehicle camera 1 captures an image in a diagonally downward direction at the rear of the vehicle S and sends the captured image to a display (not shown) in the vehicle to show the captured image. The rearview mirror in-vehicle camera 2 constantly captures an image in a rearward direction of the vehicle S and sends the captured image to a rearview mirror display (not shown) in the vehicle to show the captured image on the rearview mirror display.

The rear side of the vehicle S includes a first nozzle 3 located adjacent to and upward from the first lens surface 1a. The first nozzle 3 includes a first ejection port 3a configured to eject the air that it is supplied with toward the first lens surface 1a.

Further, the rear side of the vehicle S includes a second nozzle 4 located adjacent to and upward from the second lens surface 2a. The second nozzle 4 includes a second ejection port 4a configured to eject the air it is supplied with toward the second lens surface 2a.

The rear side of the vehicle S also includes an air pump AP that serves as a single motor-driven pump configured to supply air as a gas, which serves as a fluid, to the first ejection port 3a (first nozzle 3) and the second ejection port 4a (second nozzle 4).

As shown in FIG. 2, the air pump AP of the present embodiment is connected to an inlet 5a of a branching distributor 5, which serves as a branching portion, through a common pipe H1. A first outlet 5b of the branching distributor 5 is connected to the first nozzle 3 by a first pipe H2. A second outlet 5c of the branching distributor 5 is connected to the second nozzle 4 by a second pipe H3. The branching distributor 5 branches the passage from the air pump AP into a passage connected to the first ejection port 3a (first nozzle 3) and a passage connected to the second ejection port 4a (second nozzle 4). The branching distributor 5 is configured so that the first outlet 5b and the second outlet 5c are in constant communication with the inlet 5a. Thus, the branching distributor 5 distributes the air supplied from the air pump AP to the first ejection port 3a of the first nozzle 3 and the second ejection port 4a of the second nozzle 4 (simultaneously). In addition, the cross-sectional area of the common pipe H1 is set to be greater than or equal to a sum (preferably greater than a sum) of the cross-sectional area of the first pipe H2 and the cross-sectional area of the second pipe H3.

The air ejected from the first ejection port 3a is set to have a greater flow rate (greater flow rate per unit time) than the air ejected from the second ejection port 4a.

Specifically, the in-vehicle sensor cleaning device according to the present embodiment includes a restriction 6 arranged in the passage extending from the branching distributor 5 to the second ejection port 4a. The restriction 6 reduces the cross-sectional area of the passage from other portions so that air is ejected from the first ejection port 3a at a greater flow rate than the air ejected from the second ejection port 4a. That is, the restriction 6 has the smallest cross-sectional area in the passage from the branching distributor 5 to the first ejection port 3a and the passage from the branching distributor 5 to the second ejection port 4a. The restriction 6 according to the present embodiment is arranged at the second ejection port 4a of the second nozzle 4 (specifically, a portion including the second ejection port 4a). In FIG. 2, the cross-sectional area of the passage is illustrated to be small over the entire range of the passage inside the second nozzle 4 (including the second ejection port 4a serving as its outlet). However, the restriction 6 need only be arranged at a location that includes at least the second ejection port 4a. For example, the cross-sectional area of the passage near the inlet of the second nozzle 4 may be greater than the second ejection port 4a.

The operation of the in-vehicle sensor cleaning device will now be described.

For example, when a cleaning switch (not shown) arranged near a driver seat is operated to drive the air pump AP, air is supplied from the air pump AP to the common pipe H1. The air is then distributed by the branching distributor 5, supplied to the first nozzle 3 through the first pipe H2, and supplied to the second nozzle 4 through the second pipe H3. The air is ejected from the first ejection port 3a toward the first lens surface 1a. Further, the air is ejected from the second ejection port 4a toward the second lens surface 2a. In this state, the restriction 6 functions so that air is ejected from the first ejection port 3a at a greater flow rate than the air ejected from the second ejection port 4a. This blows off foreign material from the first lens surface 1a and the second lens surface 2a and simultaneously cleans the first lens surface 1a and the second lens surface 2a.

The advantages of the present embodiment will now be described.

(1) The air ejected from the first ejection port 3a is set to have a greater flow rate (greater flow rate per unit time) than the air ejected from the second ejection port 4a. This cleans the first lens surface 1a, which requires a great flow rate for satisfactory cleaning, and the second lens surface 2a, which does not require a great flow rate, in an efficient and satisfactory manner.

Specifically, the backward movement in-vehicle camera 1 shows a captured image on the display only when the shift lever is moved to the reverse position or the like. Even if mud or the like collects on the first lens surface 1a, the mud or the like is likely to dry without the driver noticing the mud. Thus, a great flow rate frequently becomes necessary for satisfactory cleaning. Further, the rearview mirror in-vehicle camera 2 constantly shows a captured image on the rearview mirror display device. Thus, if mud or the like collects on the second lens surface 2a, the driver is likely to quickly notice the mud (before the mud dries). Thus, a great flow rate becomes necessary less frequently, and a great flow rate for satisfactory cleaning is often unnecessary. The air ejected from the first ejection port 3a toward the first lens surface 1a is set to have a greater flow rate than the air ejected from the second ejection port 4a toward the second lens surface 2a. Thus, the first lens surface 1a and the second lens surface 2a are more likely to be cleaned in an efficient and satisfactory manner.

(2) The air pump AP, which is a single pump, includes the branching distributor 5 that branches the passage from the air pump AP into the passage connected to the first ejection port 3a and the passage connected to the second ejection port 4a. Thus, the single air pump AP cleans the portion that requires a great flow rate for satisfactory cleaning and the portion that does not require a great flow rate in an efficient and satisfactory manner.

(3) The branching distributor 5 distributes the air supplied from the air pump AP to the first ejection port 3a and the second ejection port 4a. Thus, air is simultaneously supplied from the single air pump AP to the first ejection port 3a and the second ejection port 4a. The restriction 6 is arranged in the passage extending from the branching distributor 5 to the second ejection port 4a. The restriction 6 reduces the cross-sectional area of the passage from other portions so that air is ejected from the first ejection port 3a at a greater flow rate than the air ejected from the second ejection port 4a. Thus, air is ejected from the first ejection port 3a at a greater flow rate than the air ejected from the second ejection port 4a. By driving the single air pump AP with a simple configuration, the first lens surface 1a and the second lens surface 2a are simultaneously cleaned in an efficient and satisfactory manner.

(4) The restriction 6 is arranged at the second ejection port 4a. Thus, the air passing through the restriction 6 is ejected toward the second lens surface 2a without losing force. In this manner, the second lens surface 2a is cleaned more effectively than when the restriction 6 is located closer to the branching distributor 5 than the second ejection port 4a.

The above embodiment may be modified as follows.

In the above embodiment, the restriction 6 is arranged at the second ejection port 4a of the second nozzle 4 (portion including second ejection port 4a). Instead, the restriction 6 may be arranged at another portion of the passage extending from the branching distributor 5 to the second ejection port 4a.

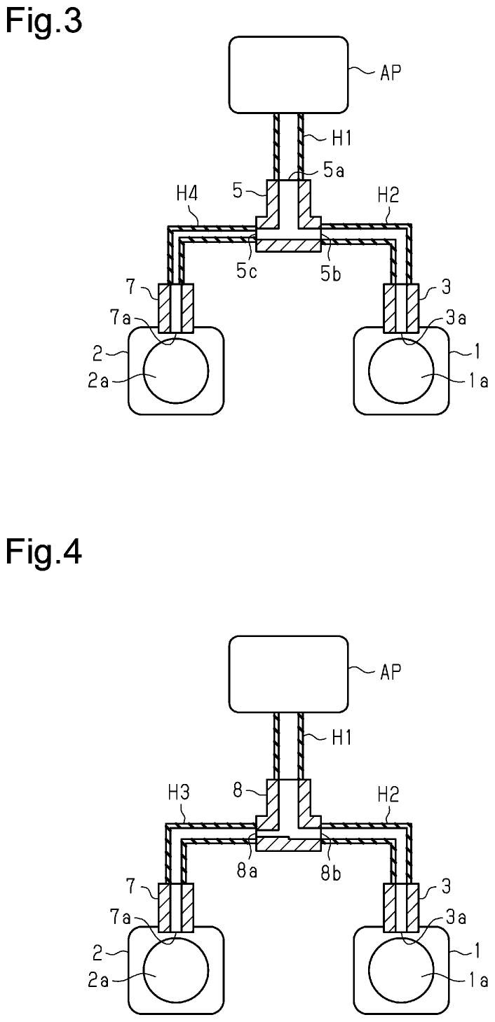

For example, as shown in FIG. 3, the second pipe H3 of the above embodiment may be replaced with a second pipe H4 having a smaller cross-sectional area. That is, in this example, the second pipe H4 comprises the restriction. In this example, the second nozzle 4 of the above embodiment is replaced with a second nozzle 7 that does not include the restriction, and a second ejection port 7a is configured to eject air. This obtains advantages (1) to (3) in the above embodiment.

Further, as shown in FIG. 4, the branching distributor 5 of the above embodiment may be replaced with a branching distributor 8 that includes a second outlet 8a having a smaller cross-sectional area. That is, in this example, a first outlet 8b of the branching distributor 8 is connected to the first nozzle 3 by the first pipe H2, and the second outlet 8a is connected to the second nozzle 7 by the second pipe H3. The cross-sectional area of the second outlet 8a is smaller than the cross-sectional area of the first outlet 8b. The second outlet 8a comprises the restriction. This obtains advantages (1) to (3) of the above embodiment.

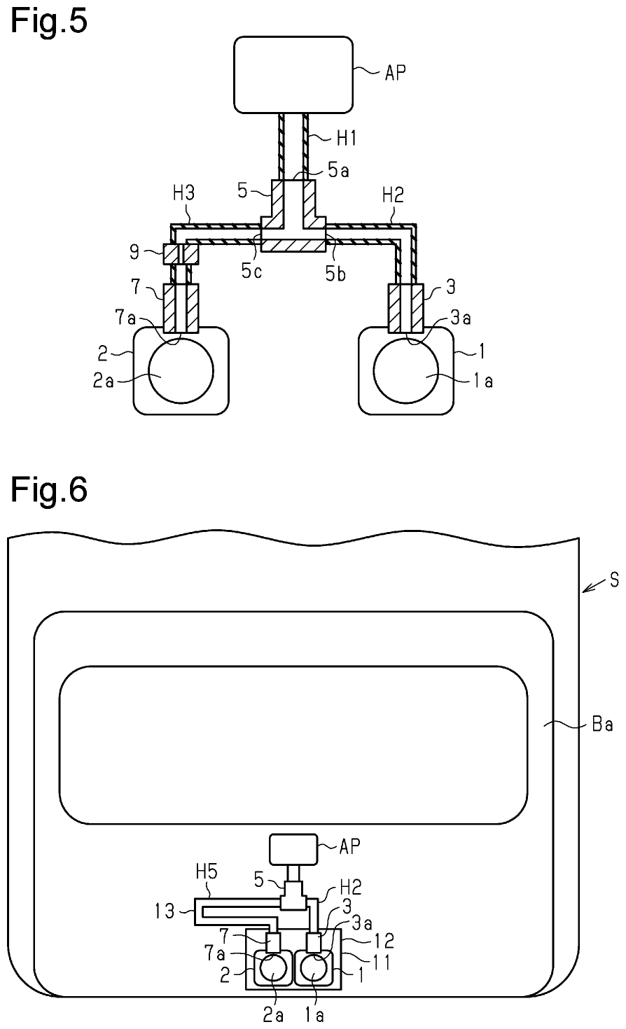

Further, as shown in FIG. 5, an orifice 9 having a smaller cross-sectional area may be arranged in the second pipe H3 of the above embodiment. That is, in this example, the orifice 9 comprises the restriction. This obtains advantages (1) to (3) of the above embodiment.

In the above embodiment, the restriction 6 having a smaller cross-sectional area ejects the air from the first ejection port 3a at a greater flow rate (greater flow rate per unit time) than the air ejected from the second ejection port 4a. However, a modification may be made to obtain the same flow rate with a different construction.

For example, a modification may be made as shown in FIG. 6. In this example, the backward movement in-vehicle camera 1 and the rearview mirror in-vehicle camera 2 are arranged next to each other on a single base member 11 to form part of a sensor module 12. The in-vehicle sensor cleaning device includes a passage extension 13 that lengthens the passage from the branching distributor 5 to the second ejection port 7a as compared with the passage from the branching distributor 5 to the first ejection port 3a so that air is ejected from the first ejection port 3a at a greater flow rate than the air ejected from the second ejection port 7a. In this example, the second pipe H3 of the above embodiment is replaced with a second pipe H5 that is longer than the first pipe H2, and the second pipe H5 comprises the passage extension 13.

With this configuration, the backward movement in-vehicle camera 1 and the rearview mirror in-vehicle camera 2 are arranged next to each other on the single base member 11 and construct the sensor module 12. Thus, the distances from the air pump AP are substantially the same. Since the branching distributor 5 distributes the air supplied from the air pump AP to the first ejection port 3a and the second ejection port 7a, air is simultaneously supplied from the single air pump AP to the first ejection port 3a and the second ejection port 7a. Further, with the passage extension 13, air is ejected from the first ejection port 3a at a greater flow rate than the air ejected from the second ejection port 7a even though the distance from the air pump AP is substantially the same. Thus, by driving the single air pump AP, the first lens surface 1a and the second lens surface 2a arranged next to each other are simultaneously cleaned in an efficient and satisfactory manner.

In the above embodiment, the in-vehicle sensor cleaning device includes the first nozzle 3 having the first ejection port 3a and the second nozzle 4 having the second ejection port 4a. However, the first nozzle 3 and the second nozzle 4 do not need to be separate. A single nozzle member may include the first ejection port 3a and the second ejection port 4a.

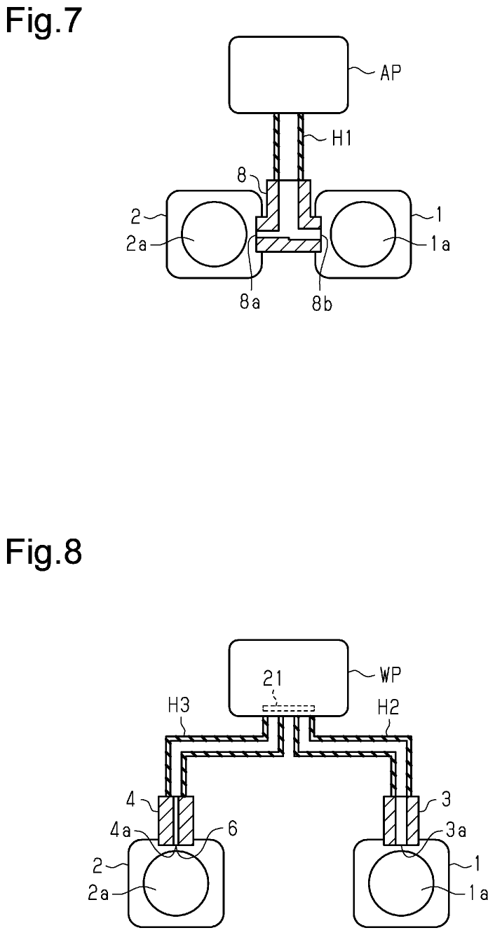

Specifically, as shown in FIG. 7, the branching distributor 8 may construct the single nozzle member such that the first outlet 8b of the branching distributor 8 in the above modified example (see FIG. 4) functions as the first ejection port and the second outlet 8a functions as the second ejection port.

In the above embodiment, the present invention is applied to the in-vehicle sensor cleaning device that ejects air and includes the air pump AP serving as a motor-driven pump. However, the present invention may be applied to an in-vehicle sensor cleaning device that ejects another fluid. For example, the present invention may be applied to an in-vehicle sensor cleaning device that uses a washer pump instead of the air pump AP of the above embodiment to supply and eject cleaning liquid. Further, the present invention may be applied to an in-vehicle sensor cleaning device that uses the air pump AP and the washer pump to mix and eject air and cleaning liquid. Further, when the present invention is applied to the in-vehicle sensor cleaning device that ejects cleaning liquid, the restriction may be arranged at a check valve arranged in a passage.

In the above embodiment, the present invention is applied to the in-vehicle sensor cleaning device including the branching distributor 5 that simultaneously ejects air from the first ejection port 3a and the second ejection port 4a. Instead, for example, the present invention may be applied to an in-vehicle sensor cleaning device including a washer pump that selectively supplies cleaning liquid to the first ejection port 3a and the second ejection port 4a by rotating an impeller in forward and reverse directions.

Specifically, as shown in FIG. 8, for example, an impeller 21 is arranged inside a washer pump WP. The washer pump WP supplies cleaning liquid from a washer tank (not shown) only to the first ejection port 3a of the first nozzle 3 (first pipe H2) when the impeller 21 is rotated in the forward direction and supplies the cleaning liquid from the washer tank only to the second ejection port 4a of the second nozzle 4 (second pipe H3) when the impeller 21 is rotated in the reverse direction. This cleans the first lens surface 1a that requires a great flow rate for satisfactory cleaning and the second lens surface 2a that does not require a great flow rate in an efficient and satisfactory manner.

In the above example (see FIG. 8), with the configuration in which the restriction 6 having a smaller cross-sectional area is arranged at the second ejection port 4a (portion including second ejection port 4a), the cleaning liquid is ejected from the first ejection port 3a at a greater flow rate than the cleaning liquid ejected from the second ejection port 4a. However, the amount of cleaning liquid supplied from the washer pump WP may differ between forward and reverse rotations. For example, when the washer pump WP is employed, the shape of the impeller 21 may be set to supply cleaning liquid having a great flow rate to the first ejection port 3a when rotated forward and supply cleaning liquid having a smaller flow rate to the second ejection port 4a when rotated backward. In this case, the restriction 6 does not need to be arranged at the second ejection port 4a.

Further, the branching distributor 5 of the above embodiment may be replaced with a switch branching unit that switches one of the first ejection port 3a and the second ejection port 4a supplied with the fluid from the motor-driven pump (air pump AP or washer pump WP).

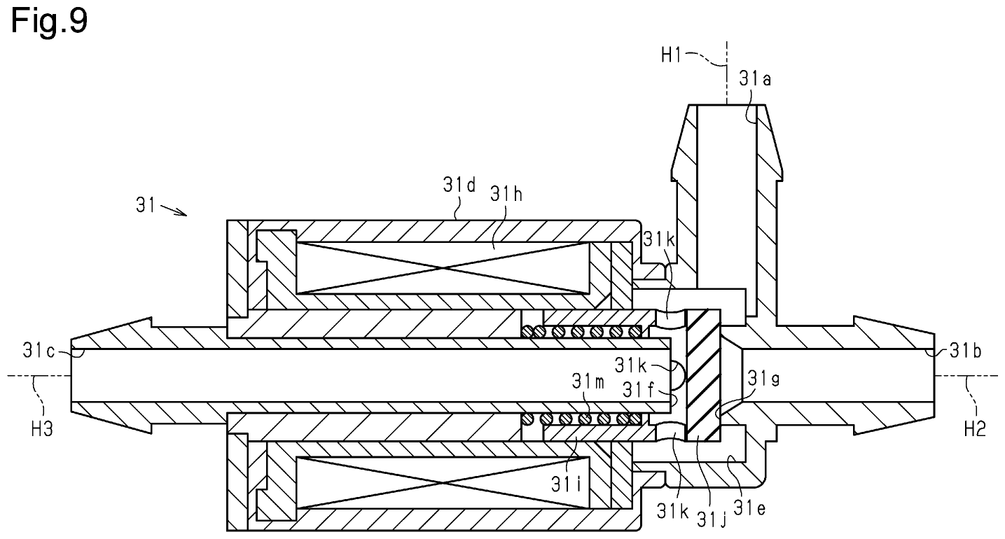

Specifically, the branching distributor 5 may be replaced with a switch branching unit 31 shown in FIG. 9. The switch branching unit 31 includes an inlet 31a connected to the common pipe H1 of the above embodiment, a first outlet 31b connected to the first pipe H2, and a second outlet 31c connected to the second pipe H3. The switch branching unit 31 is an electromagnetic switching valve, in which a branch chamber 31e is defined inside a case 31d. An inner opening 31f of the second outlet 31c and an inner opening 31g of the first outlet 31b are spaced apart and opposed to each other inside the branch chamber 31e. Further, an inner opening of the inlet 31a is arranged beside (portion in circumferential direction) the branch chamber 31e. The passage (left side in FIG. 9) of the second outlet 31c inside the case 31d includes an exciting coil 31h that surrounds the passage of the second outlet 31c, and the inner side of the exciting coil 31h (outer side of the passage of the second outlet 31c) includes a metal pipe member 31i that is movable in an opposing direction of the inner openings 31f and 31g (right-left direction in FIG. 9). A valve body 31j is fixed to an end (right end in FIG. 9) of the pipe member 31i, in which the end is located between the inner openings 31f and 31g. Further, a plurality of communication holes 31k are formed in the end of the pipe member 31i next to one another in the circumferential direction. The pipe member 31i is biased by a compression coil spring 31m, which serves as a biasing means, to close the inner opening 31g when the valve body 31j is pressed into contact with the inner opening 31g of the first outlet 31b.

With the switch branching unit 31, when the exciting coil 31h is not driven and the exciting coil 31h is thereby in a non-excitation state, the biasing force of the compression coil spring 31m presses the valve body 31j into contact with the inner opening 31g of the first outlet 31b to close the inner opening 31g and connect the inner opening 31f of the second outlet 31c to the inlet 31a (via communication holes 31k). Further, with the switch branching unit 31, when the exciting coil 31h is driven and the exciting coil 31h is in an excitation state, the pipe member 31i and the valve body 31j are driven (leftward in FIG. 2) against the biasing force of the compression coil spring 31m and pressed into contact with the inner opening 31f of the second outlet 31c to close the inner opening 31f and connect the inner opening 31g of the first outlet 31b to the inlet 31a.

When the branching distributor 5 is replaced with such a switch branching unit 31, a single air pump AP switches liquid supplied to the first lens surface 1a that requires a great flow rate for satisfactory cleaning and the second lens surface 2a that does not require a great flow rate to perform cleaning in an efficient and satisfactory manner.

In the above embodiment, the first ejection port 3a and the second ejection port 4a each have a single port. Instead, a plurality of first ejection ports may be included to clean the same portion and a plurality of second ejection ports may be included to clean the same portion.

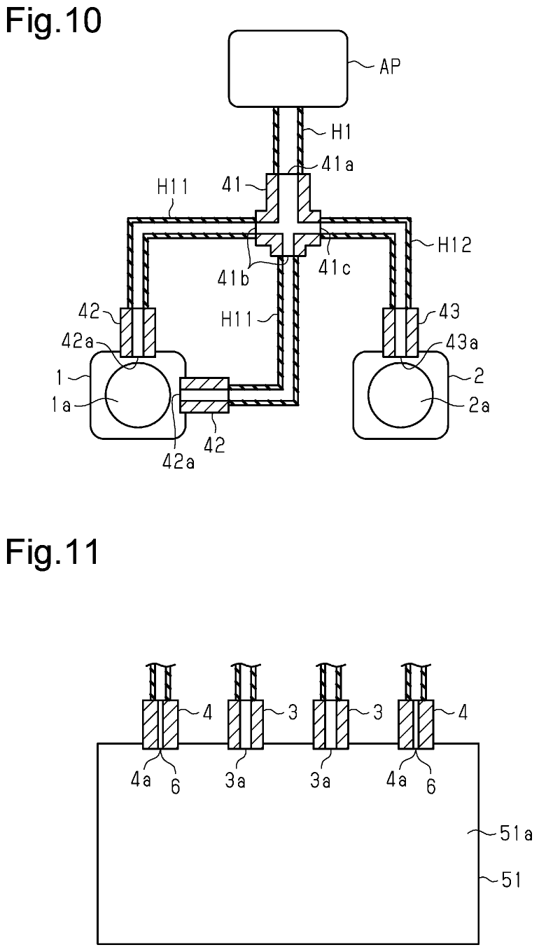

For example, a modification may be made as shown in FIG. 10. In this example, the air pump AP is connected to an inlet 41a of a branching distributor 41, which serves as a branching unit, by the common pipe H1. Two first outlets 41b of the branching distributor 41 are connected to two first nozzles 42 by first pipes H11. A single second outlet 41c of the branching distributor 41 is connected to a single second nozzle 43 by a second pipe H12. The branching distributor 41 branches the passage from the air pump AP into a passage connected to first ejection ports 42a of the first nozzles 42 and a passage connected to the second ejection port 43a of the second nozzle 43. The branching distributor 41 is configured so that the two first outlets 41b and the single second outlet 41c are in constant communication with the inlet 41a. Thus, the branching distributor 41 distributes the air supplied from the air pump AP to the two first ejection ports 42a of the two first nozzles 42 and the second ejection port 43a of the second nozzle 43 (simultaneously). The two first ejection ports 42a are each arranged to eject the supplied air toward the first lens surface 1a. The total amount of the air ejected from the two first ejection ports 42a toward the first lens surface 1a is set to have a greater flow rate (greater flow rate per unit time) than the air ejected from the second ejection port 43a toward the second lens surface 2a. This cleans the first lens surface 1a and the second lens surface 2a in an efficient and satisfactory manner.

The above embodiment includes the first in-vehicle sensor as the backward movement in-vehicle camera 1 and the second in-vehicle sensor as the rearview mirror in-vehicle camera 2. However, the first in-vehicle sensor and the second in-vehicle sensor may be replaced with other sensors. Further, each of the first in-vehicle sensor and the second in-vehicle sensor do not need to be a single sensor. For example, there may be a plurality of the first in-vehicle sensors and a plurality of the second in-vehicle sensors. The first in-vehicle sensor and the second in-vehicle sensor may be arranged at the front side of the vehicle. Further, the first in-vehicle sensor and the second in-vehicle sensor may be arranged at one lateral side of the vehicle.

In a construction including only a single in-vehicle sensor having a relatively large sensing surface, the first ejection port and the second ejection port may be arranged to eject fluid toward different areas of the single sensing surface.

For example, a modification may be made as shown in FIG. 11. In this example, an in-vehicle sensor 51 is arranged at the front side of the vehicle. The in-vehicle sensor 51 has a larger protection glass 51a than the first lens surface 1a of the backward movement in-vehicle camera 1 in the above embodiment. A device for cleaning the in-vehicle sensor 51 includes first nozzles 3 and second nozzles 4 arranged next to one another in the widthwise direction (right-left direction in FIG. 11) at the upper side of the protection glass 51a. The first nozzles 3 each have a first ejection port 3a and the second nozzles 4 each have a second ejection port 4a to eject the supplied fluid toward the protection glass 51a. Two first nozzles 3 are arranged next to each other and located toward the middle of the protection glass 51a in the widthwise direction with the first ejection ports 3a directed downward. Two second nozzles 4 are located toward corresponding ends of the protection glass 51a in the widthwise direction with the second ejection ports 4a directed downward. A single air pump is connected to the two first nozzles 3 and the two second nozzles 4 by, for example, a branching distributor (not shown). The branching distributor may be a switch branching unit and the air pump may be a washer pump. This cleans the middle portion of the protection glass 51a that requires a great flow rate for satisfactory cleaning and the end portions that do not require a great flow rate in an efficient and satisfactory manner.

### DESCRIPTION OF THE REFERENCE NUMERALS

1 . . . backward movement in-vehicle camera (in-vehicle sensor and first in-vehicle sensor), 1a . . . first lens surface (sensing surface), 2 . . . rearview mirror in-vehicle camera (in-vehicle sensor and second in-vehicle sensor), 2a . . . second lens surface (sensing surface), 3a, 42a . . . first ejection port, 4a, 7a, 43a . . . second ejection port, 5, 8, 41 . . . branching distributor (branching portion), 6 . . . restriction, 8a . . . second outlet (restriction, second ejection port), 8b . . . first outlet (first ejection port), 9 . . . orifice (restriction), 11 . . . base member, 12 . . . sensor module, 13 . . . passage extension, 31 . . . switch branching unit (branching portion), 51 . . . in-vehicle sensor, 51a . . . protection glass (sensing surface), AP . . . air pump (motor-driven pump), H4 . . . second pipe (restriction), WP . . . washer pump (motor-driven pump)

1. An in-vehicle sensor cleaning device configured to eject fluid toward a sensing surface of an in-vehicle sensor to clean the sensing surface, wherein the in-vehicle sensor is arranged at a front side of a vehicle, a rear side of the vehicle, or one of lateral sides of the vehicle, the in-vehicle sensor cleaning device comprising:
a first ejection port and a second ejection port configured to eject fluid toward the sensing surface of the in-vehicle sensor; and
a motor-driven pump that supplies fluid to the first ejection port and the second ejection port,
wherein the fluid ejected from the first ejection port is set to have a greater flow rate per unit time than the fluid ejected from the second ejection port.

2. The in-vehicle sensor cleaning device according to claim 1, wherein the motor-driven pump is a single pump, and
the in-vehicle sensor cleaning device further comprises a branching unit that branches a passage from the motor-driven pump into a passage connected to the first ejection port and a passage connected to the second ejection port.

3. The in-vehicle sensor cleaning device according to claim 2, wherein the branching unit is a branching distributor configured to distribute the fluid supplied from the motor-driven pump to the first ejection port and the second ejection port.

4. The in-vehicle sensor cleaning device according to claim 2, wherein the branching unit is a switch branching unit that switches one of the first ejection port and the second ejection port supplied with the fluid from the motor-driven pump.

5. The in-vehicle sensor cleaning device according to claim 2, further comprising a restriction arranged in the passage extending from the branching unit to the second ejection port, wherein the restriction reduces a cross-sectional area of the passage from other portions so that fluid is ejected from the first ejection port at a greater flow rate per unit time than the fluid ejected from the second ejection port.

6. The in-vehicle sensor cleaning device according to claim 5, wherein the restriction is arranged at the second ejection port.

7. The in-vehicle sensor cleaning device according to claim 1, wherein
the in-vehicle sensor is one of a first in-vehicle sensor and a second in-vehicle sensor that are arranged next to each other on a single base member to construct a sensor module,
the motor-driven pump is a single pump, and
the in-vehicle sensor cleaning device further comprises:
a branching unit that branches a passage from the motor-driven pump into a passage connected to the first ejection port for ejection toward a sensing surface of the first in-vehicle sensor and a passage connected to the second ejection port for ejection toward a sensing surface of the second in-vehicle sensor; and
a passage extension that lengthens the passage from the branching unit to the second ejection port as compared with the passage from the branching unit to the first ejection port so that the fluid ejected from the first ejection port has a greater flow rate per unit time than the fluid ejected from the second ejection port.

8. The in-vehicle sensor cleaning device according to claim 1, wherein the in-vehicle sensor is one of a backward movement in-vehicle camera and a rearview mirror in-vehicle camera.
